(19) United States
(12) Patent Application Publication
(10) Pub. No.: US 2014/0271391 A1
(43) Pub. Date: Sep. 18, 2014

(54) ZPGM TWC Systems Compositions and Methods Thereof

(71) Applicant: Zahra Nazarpoor, Camarillo, CA (US)

(72) Inventor: Zahra Nazarpoor, Camarillo, CA (US)

(73) Assignee: CDTI, Ventura, CA (US)

(21) Appl. No.: 13/849,191

(22) Filed: Mar. 22, 2013

Related U.S. Application Data
(60) Provisional application No. 61/792,215, filed on Mar. 15, 2013.

(51) Int. Cl. B01D 53/94

(52) U.S. Cl. CPC B01D 53/945
USPC 422/177

(57) ABSTRACT

Compositions and methods for the preparation of ZPGM TWC systems are disclosed. ZPGM TWC systems may be employed within catalytic converters to oxidize toxic gases, such as carbon monoxide and other hydrocarbons, as well as to reduce nitrogen oxides. ZPGM TWC systems are completely free of PGM catalyst and may include: a substrate, a washcoat, and an overcoat. Washcoat may include manganese as ZPGM catalyst, and carrier material oxides. Similarly, overcoat may include at least one ZPGM catalyst, carrier material oxides and OSMs. Suitable known in the art chemical techniques, deposition methods and treatment systems may be employed in order to form the disclosed ZPGM TWC systems. ZPGM TWC systems may include high surface area, low conversion temperature catalysts that may exhibit high efficiency in the conversion of exhaust gases.

### CROSS-REFERENCE TO RELATED APPLICATIONS

The present application claims priority to 61/792,215, filed Mar. 15, 2013, and is related to U.S. patent application Ser. No. 12/229,792, entitled Zero Platinum Group Metal Catalysts, filed Aug. 26, 2008, and U.S. patent application Ser. No. 12/791,699, entitled Zero Platinum Group Metal Catalysts, filed Jun. 1, 2010, the entireties of which are incorporated herein by reference.

### BACKGROUND

1. Field of the Disclosure

The present disclosure relates generally catalyst systems, and more particularly to compositions and methods for the preparation of Zero Platinum Group Metal (ZPGM) TWC systems.

2. Background

Catalysts in catalytic converters have been used to decrease the pollution caused by exhaust from various sources, such as automobiles, utility plants, processing and manufacturing plants, airplanes, trains, all-terrain vehicles, boats, mining equipment, and other engine-equipped machines. Important pollutants in the exhaust gas of engines may include carbon monoxide (CO), unburned hydrocarbons (HC), nitrogen oxides (NOx), and particulate matter (PM). Common three way catalysts (TWC) may work by converting carbon monoxide, hydrocarbons and nitrogen oxides into less harmful compounds or pollutants.

TWC within catalytic converters are generally fabricated using at least some platinum group metals (PGM). With the ever stricter standards for acceptable emissions, the demand on PGM continues to increase due to their efficiency in removing pollutants from exhaust. However, this demand, along with other demands for PGM, places a strain on the supply of PGM, which in turn drives up the cost of PGM and therefore catalysts and catalytic converters.

For the foregoing reasons, there is a need for improved TWC systems that do not require PGM and that may exhibit similar or better efficiency than prior art three way catalyst converters.

### SUMMARY

The present disclosure includes compositions and methods for the preparation of Zero Platinum Group Metal (ZPGM) TWC systems that may be employed to oxidize carbon monoxide and hydrocarbons, as well as to reduce NOx included in exhaust gases. The disclosed catalysts are completely free of PGM, as such; they are referred to as ZPGM catalysts. ZPGM catalysts in the form of aqueous slurry, as a coating, may be deposited on suitable substrates in order to fabricate ZPGM TWC systems that may be employed within catalytic converters which may be used to convert toxic exhaust gases such as CO to less harmful carbon dioxide, and oxidizing unburnt HC's to carbon dioxide and water. Additionally, catalytic converters including the ZPGM TWC systems may reduce NOx to nitrogen and oxygen.

The disclosed ZPGM TWC systems may include three layers of materials: a substrate, a washcoat, and an overcoat. Substrates may be in the form of beads or pellets or any suitable form. Furthermore, substrates may be made from a refractive material, a ceramic substrate, a honeycomb structure, a metallic substrate, a ceramic foam, a metallic foam, a reticulated foam, or any suitable combination.

In the present disclosure, washcoats generally include at least one ZPGM transition metal catalyst, such as manganese, and carrier material oxides. Most suitable carrier material oxide for washcoat may be aluminum oxide. Moreover, according to an embodiment of the present disclosure, overcoat may include not only ZPGM transition metal catalysts such as copper, rare earth metals such cerium, and carrier material oxides, but also oxygen storage materials (OSM's). Most suitable carrier material oxide for overcoat may be pure aluminum oxide or alumina-lanthanum mixtures. Other embodiments of the present disclosure may include other materials. Some embodiments of the present disclosure may include manganese and cerium catalysts within washcoat and copper catalyst within overcoat, among other materials.

In order to prepare washcoat catalysts and overcoat catalysts an aqueous slurry is produced which may be used as coatings to fabricate the disclosed ZPGM TWC systems; a co-milling process may be employed. In the present disclosure, the ZPGM catalysts already form part of the washcoat slurry and overcoat slurry, as such; both washcoat or overcoat materials and ZPGM catalysts may be deposited on a substrate in a single step. In other embodiments, ZPGM catalysts may be impregnated onto the washcoat layer. Similarly ZPGM catalysts may also be impregnated onto the overcoat layer.

In some embodiments, washcoat catalysts and overcoat catalysts may be synthesized by any suitable chemical technique such as co-precipitation or any other suitable technique known in the art. The aqueous slurry, including washcoat catalysts, may be deposited on a suitable substrate in order to form a washcoat.

In one embodiment, vacuum dosing and coating systems may be employed to deposit washcoat slurry on a substrate as well as overcoat slurry on a washcoat. Moreover, other deposition methods may be employed to deposit the catalysts aqueous slurry.

In one embodiment, the washcoat may be treated with heat before an overcoat is deposited on the washcoat. In other embodiments, an overcoat may be deposited on the washcoat before the washcoat is treated and subsequently, both washcoat and overcoat may be simultaneously treated with heat. In one embodiment, treatment may be achieved by employing firing systems. Other embodiments may employ other suitable treatment systems.

The disclosed ZPGM TWC catalyst systems may be employed within catalytic converters. ZPGM TWC systems of the present disclosure may include high surface area, low conversion temperature catalysts that may convert toxic exhaust gas into less harmful compounds.

### BRIEF DESCRIPTION OF THE DRAWINGS

Embodiments of the present disclosure are described by way of example with reference to the accompanying figures. which are schematic and are not intended to be drawn to scale.

FIG. 1 is ZPGM TWC system configuration, according to an embodiment.

FIG. 2 is a flowchart of method for preparation of a washcoat and an overcoat, according to an embodiment.

FIG. 3 shows disclosed ZPGM TWC system light-off test results.

FIG. 4 shows disclosed ZPGM TWC system light-off test results.

FIG. 5 shows example #1 ZPGM TWC system light-off test results.

FIG. 6 shows example #1 ZPGM TWC system light-off test results.

FIG. 7 shows example #2 ZPGM TWC system light-off test results.

FIG. 8 shows example #2 ZPGM TWC system light-off test results.

### DETAILED DESCRIPTION

The present disclosure is hereby described in detail with reference to embodiments illustrated in the drawings, which form a part hereof. Other embodiments may be used and/or and other changes may be made without departing from the spirit or scope of the present disclosure. The illustrative embodiments described in the detailed description are not meant to be limiting of the subject matter presented herein.

### DEFINITIONS

As used herein, the following terms have the following definitions:

“Catalyst system” refers to a system of at least two layers including at least one substrate, a washcoat, and/or an overcoat.

“Substrate” refers to any suitable material for supporting a catalyst and can be of any shape or configuration that yields a sufficient surface area for the deposition of a washcoat.

“Washcoat” refers to at least one coating including at least one oxide solid that may be deposited on a substrate.

“Overcoat” refers to at least one coating including one or more oxide solid that may be deposited on at least one washcoat.

“Oxide solid” refers to any mixture of materials selected from the group including a carrier material oxide, a catalyst, and a mixture thereof.

“Carrier material oxide” refers to materials used for providing a surface for at least one catalyst.

“Oxygen storage material” refers to materials that can take up oxygen from oxygen-rich feed streams and release oxygen to oxygen-deficient feed streams.

“Three-Way Catalyst” refers to a catalyst that may achieve three simultaneous tasks: reduce nitrogen oxides to nitrogen, oxidize carbon monoxide to carbon dioxide and oxidize unburnt hydrocarbons to carbon dioxide and water.

“ZPGM Transition Metal Catalyst” refers to at least one catalyst that includes at least one transition metal that is completely free of platinum group metals.

“Impregnation component” refers to at least one component added to a washcoat and/or overcoat to yield a washcoat and/or overcoat including at least one catalyst.

“Platinum group metals” refers to platinum, palladium, ruthenium, iridium, osmium, and rhodium.

“Treating,” “treated,” or “treatment” refers to drying, firing, heating, evaporating, calcining, or mixtures thereof.

“Exhaust” refers to the discharge of gases, vapor, and fumes created by and released at the end of a process, including hydrocarbons, nitrogen oxide, and/or carbon monoxide.

### Description of Drawings

Compositions and methods for preparation of ZPGM TWC systems are disclosed. Disclosed ZPGM TWC systems may include at least one ZPGM catalyst.

### ZPGM TWC System Configuration and Composition

FIG. 1 depicts ZPGM TWC System 100 configuration of the present disclosure. As shown in FIG. 1, ZPGM TWC System 100 may include at least a Substrate 102, a Washcoat 104, and an Overcoat 106, where Washcoat 104 and Overcoat 106 may include at least one ZPGM catalyst.

### Substrate Materials

In an embodiment of the present disclosure, Substrate 102 materials may include a refractive material, a ceramic material, a honeycomb structure, a metallic material, a ceramic foam, a metallic foam, a reticulated foam, or suitable combinations, where Substrate 102 may have a plurality of channels with suitable porosity. Porosity may vary according to the particular properties of Substrate 102 materials. Additionally, the number of channels may vary depending upon Substrate 102 used as is known in the art. The type and shape of a suitable Substrate 102 would be apparent to one of ordinary skill in the art.

In one embodiment, Substrate 102 may be in the form of beads or pellets or of any suitable form. The beads or pellets may be formed from any suitable material such as alumina, silica alumina, silica, titania, mixtures thereof, or any suitable material. In some embodiments a ceramic honeycomb Substrate 102 may be used, which may be formed from any suitable material such as sillimanite, zirconia, petalite, spodumene (lithium aluminum silicate), magnesium silicates, mullite, alumina, cordierite (e.g. Mg₂A₁₄Si₅O₁₈), other alumino-silicate materials, silicon carbide, aluminum nitride, or combinations thereof. Other ceramic substrates 102 would be apparent to one of ordinary skill in the art.

If Substrate 102 is a metal honeycomb Substrate 102, the metal may be a heat-resistant base metal alloy, particularly an alloy in which iron is a substantial or major component. The surface of the metal Substrate 102 may be oxidized at elevated temperatures above about 1000° C. to improve the corrosion resistance of the alloy by forming an oxide layer on the surface of the alloy. The oxide layer on the surface of the alloy may also enhance the adherence of a Washcoat 104 to the surface of a monolith Substrate 102.

In some embodiments, Substrate 102 may be a monolithic carrier having a plurality of fine, parallel flow passages extending through the monolith. The passages can be of any suitable cross-sectional shape and/or size. The passages may be, for example trapezoidal, rectangular, square, sinusoidal, hexagonal, oval, or circular, although other shapes are also suitable. The monolith may contain from about 9 to about 1200 or more gas inlet openings or passages per square inch of cross section, although fewer passages may be used.

### Washcoat Composition

According to an embodiment of the present disclosure, Washcoat 104 may include at least one ZPGM transition metal catalyst. A ZPGM transition metal catalyst may include one or more transition metals that are completely free of PGM. ZPGM transition metal catalyst may include scandium, titanium, vanadium, chromium, manganese, iron, cobalt, nickel, copper, zinc, yttrium, zirconium, niobium, molybdenum, silver, cadmium, hafnium, tantalum, tungsten, rhenium, and gallium. Most suitable ZPGM transition metal for the present disclosure may be manganese. The total amount of manganese may be of about 1% by weight to about 20% by weight of the total catalyst weight, preferred being 4% to 10% by weight.

According to other embodiments, Washcoat 104 may include manganese and or cerium as catalysts.

In other embodiments, additional single ZPGM transition metals or ZPGM transition metal combinations may be included in Washcoat 104 composition.

Additionally, Washcoat 104 may include support oxides material referred to as carrier material oxides. Carrier material oxides may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. Suitable carrier material oxides for the disclosed Washcoat 104 may include one or more selected from the group consisting of aluminum oxide (Al₂O₃) or doped aluminum oxide. The doped aluminum oxide in Washcoat 104 may include one or more selected from the group consisting of lanthanum, yttrium, lanthanides and mixtures thereof. The amount of doped lanthanum in alumina may vary from 0 percent (i.e., pure aluminum oxide) to 10 percent lanthanum oxide by weight; most suitable 4% to 10% lanthanum oxide by weight. Other mixtures of alumina-lanthanum may also be included in other embodiments of Washcoat 104. Carrier material oxide may be present in Washcoat 104 in a ratio of about 40 to about 60 by weight. Carrier material oxides are normally inert and stable at high temperatures (>1000° C.) and under a range of reducing and oxidizing conditions.

In the present embodiment, Washcoat 104 may include oxygen storage materials (OSM), such as cerium, zirconium, samarium, lanthanum, yttrium, lanthanides, actinides, and mixtures thereof.

In some embodiments, Washcoat 104 may also include other components such as acid or base solutions or various salts or organic compounds that may be added in order to adjust rheology of the Washcoat 104 slurry and to enhance the adhesion of Washcoat 104 to Substrate 102. Some examples of compounds that can be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol and other suitable compounds. Preferred solution to enhance binding of Washcoat 104 to Substrate 102 may be tetraethyl ammonium hydroxide.

In other embodiments, other components known to one of ordinary skill in the art may be included in Washcoat 104.

### Overcoat Composition

One embodiment of the present disclosure includes an Overcoat 106 within ZPGM TWC System 100. Overcoat 106 may include ZPGM transition metal catalysts that may include one or more transition metals, and least one rare earth metal, or mixture thereof that are completely free of PGM. The transition metals may be a single transition metal, or a mixture of transition metals which may include chromium, manganese, iron, cobalt, nickel, copper, niobium, molybdenum, and tungsten. Most suitable ZPGM transition metal may be copper. Preferred rare earth metal may be cerium. The total amount of copper metal included in Overcoat 106 may be of about 5% by weight to about 30% by weight of the total catalyst weight, most suitable of about 10% to 16% by weight. Furthermore, the total amount of cerium metal included in Overcoat 106 may be of about 5% by weight to about 50% by weight of the total catalyst weight, most suitable of about 10% to 20% by weight. In embodiments, different suitable copper salts as well as different suitable cerium salts such as nitrate, acetate or chloride may be used as ZPGM precursors.

In other embodiments, additional ZPGM transition metals may be included in Overcoat 106 composition.

According to the present embodiment, Overcoat 106 may include carrier material oxides. Carrier material oxides may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. Suitable carrier material oxides for the disclosed Overcoat 106 may include one or more selected from the group consisting of aluminum oxide (Al₂O₃) or doped aluminum oxide. The doped aluminum oxide in Overcoat 106 may include one or more selected from the group consisting of lanthanum, yttrium, lanthanides and mixtures thereof. The amount of doped lanthanum in alumina may vary from 0 percent (i.e., pure aluminum oxide) to 10 percent lanthanum oxide by weight; most suitable 5% to 10% lanthanum oxide by weight. Other mixtures of alumina-lanthanum may also be included in other embodiments of Overcoat 106. Carrier material oxide may be present in Overcoat 106 in a ratio of about 40 to about 60 by weight.

Additionally, according to one embodiment, Overcoat 106 may also include OSM. Amount of OSM may be of about 10 to about 60 weight percent, most suitable of about 20 to about 40 weight percent. The weight percent of OSM is on the basis of the oxides. The OSM may include at least one oxide selected from the group consisting of cerium, zirconium, lanthanum, yttrium, lanthanides, actinides, and mixtures thereof. OSM in the present Overcoat 106 may be a mixture of ceria and zirconia; more suitable a mixture of (1) ceria, zirconia, and lanthanum or (2) ceria, zirconia, neodymium, and praseodymium. In addition to oxygen storage property, OSM may improve the adhesion of Overcoat 106 to Washcoat 104.

In other embodiments, other components known to one of ordinary skill in the art may be included in Overcoat 106.

In an embodiment, Washcoat 104 may be formed on Substrate 102 by suspending the oxide solids in water to form an aqueous slurry and depositing the aqueous slurry on Substrate 102 as Washcoat 104. Subsequently, in order to form ZPGM TWC System 100, Overcoat 106 may be deposited on Washcoat 104.

Method for Preparation of Washcoat and Overcoat

FIG. 2 is a flowchart of Method for Preparation 200 of Washcoat 104 and Overcoat 106, according to an embodiment.

According to the present disclosure, Washcoat 104 may be prepared by following Method for Preparation 200. In an embodiment, Method for Preparation 200 may be a “co-milling process” which may begin with Mixing 202 process. In Mixing 202 process, powder forms including Washcoat 104 or Overcoat 106 materials may be mixed with water or any suitable organic solvent. Suitable organic solvents may include ethanol, Diethyl Ether, Carbon Tetrachloride, Trichloroethylene, among others. Powder forms for Washcoat 104 or Overcoat 106 may include ZPGM transition metal catalyst, and carrier material oxides, previously described in Washcoat 104 composition and Overcoat 106 composition. Subsequently, mixed powder forms may undergo Milling Process 204 in which Washcoat 104 or Overcoat 106 materials may be broken down into smaller particle sizes. Milling Process 204 may take about 10 minutes to about 10 hours, depending on the batch size, kind of material and particle size desired. In one embodiment of the present disclosure, suitable average particle size (APSs) of the slurry may be of about 4 microns to about 10 microns, in order to get uniform distribution of Washcoat 104 particles or Overcoat 106 particles. Finer particles may have more coat ability and better adhesion to Substrate 102 and enhanced cohesion between Washcoat 104 and Overcoat 106 layers. Milling Process 204 may be achieved by employing any suitable mill such as vertical or horizontal mills. In order to measure exact particle size desired during Milling Process 204, a laser light diffraction equipment may be employed. After Milling Process 204, a catalyst aqueous slurry may be obtained. In order to enhance binding property Washcoat 104 to Substrate 102, aqueous slurry obtained in Milling Process 204 may undergo Adjusting Rheology 206 step. In Adjusting Rheology 206 step, acid or base solutions or various salts or organic compounds may be added to the aqueous slurry. Some examples of compounds that can be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol and other suitable compounds. All steps included in Method for Preparation 200 may be achieved within room temperature.

Similarly, in an embodiment, Overcoat 106 may be prepared by co-milling method, following all steps described in Method for Preparation 200, in which ZPGM transition metal catalysts, OSM and carrier material oxides included in Overcoat 106 materials may be mixed in Mixing 202 process. Subsequently, mixed materials may undergo Milling Process 204 and Adjusting Rheology 206 process in order to obtain Overcoat 106 aqueous slurry.

In other embodiments, Washcoat 104 and Overcoat 106 may be synthesized by any chemical technique such as, co-precipitation, or any other technique known in the art.

Furthermore, the milled Washcoat 104, in the form of aqueous slurry or coating may be deposited on Substrate 102 and subsequently, Washcoat 104 may be treated.

Disclosed Washcoat 104 and Overcoat 106 may exhibit specific surface area (SSAs) of about 100 to 140 m²/g.

### Washcoat and Overcoat Deposition Methods and Treatment Methods

According to an embodiment, at least a portion of the catalyst or catalysts of the present disclosure may be placed on Substrate 102 in the form of Washcoat 104 coating. Subsequently, Overcoat 106 may be deposited on Washcoat 104.

According to the present disclosure, the aqueous slurry including Washcoat 104, may be deposited on a suitable Substrate 102 employing vacuum dosing and coating systems.

In some embodiments, other deposition methods may be employed, such as placing, adhering, curing, coating, spraying, dipping, painting, or any known process for coating a film on at least one Substrate 102. If Substrate 102 is a monolithic carrier with parallel flow passages, Washcoat 104 may be formed on the walls of the passages. Gas flowing through the flow passages can contact Washcoat 104 on the walls of the passages as well as materials that are supported on Washcoat 104.

Various amounts of Washcoat 104 of the present disclosure may be coated on Substrate 102, preferably an amount that covers most of, or all of, the surface area of Substrate 102. In an embodiment, about 60 g/L to about 200 g/L of Washcoat 104 may be coated on Substrate 102.

In an embodiment, after depositing Washcoat 104 on Substrate 102. Washcoat 104 may be treated in order to convert metal salts within Washcoat 104 into metal oxides.

In one embodiment Washcoat 104 may be treated by drying and then heating Washcoat 104. In order to dry Washcoat 104, air knife drying systems may be employed. Additionally, Washcoat 104 may be treated by employing firing systems or any suitable treatment system. The treatment may take from about 2 hours to about 6 hours, preferably about 4 hours and at a temperature of about 300° C. to about 700° C., preferably about 550° C.

In one embodiment, after Washcoat 104 has been treated and cooled to about room temperature, Overcoat 106 may be deposited on Washcoat 104 by employing suitable deposition techniques such as vacuum dosing, among others. Overcoat 106 may then be dried and treated employing suitable treating techniques such as firing systems, among others.

In other embodiments, treating of Washcoat 104 may not be required prior to application of Overcoat 106. As such; Overcoat 106, Washcoat 104 and Substrate 102 may be treated for about 2 hours to about 6 hours, preferably about 4 hours and at a temperature of 300° C. to about 700° C., preferably about 550° C.

In some embodiments, an impregnation component may be deposited on Washcoat 104 or/and Overcoat 106. The impregnation component may include one or more selected from the group consisting of a transition metal, alkali and alkaline earth metal, cerium, lanthanum, yttrium, lanthanides, actinides, and mixtures thereof.

In other embodiments, Washcoat 104 and/or Overcoat 106 may be deposited in different ways; for example, depositing composition materials without catalysts, and then separately depositing at least one impregnation component and heating (this separate deposit is also referred to as an impregnation step).

### EXAMPLES

Example #1 is an embodiment of ZPGM TWC System 100 that includes the following Washcoat 104 and Overcoat 106 compositions:

| | | | CARRIER MATERIAL |
|---|---|---|---|
| LAYER | ZPGM | OSM | OXIDES |
| WASHCOAT | Mn | Ce—Zr—Nd—Pr | Lanthanum doped |
| | | | alumina |
| OVERCOAT | Cu—Ce | Ce—Zr—Nd—Pr | Lanthanum doped |
| | | | Alumina |

FIG. 3 shows example #1 ZPGM TWC system light-off test results 300, in which example #1 ZPGM catalyst system may be formulated with 4-20% by weight of Mn, lanthanum doped alumina, and suitable OSM in Washcoat 104; 10-16% by weight of Cu, 10-20% by weight of Ce, lanthanum doped alumina, and suitable OSM in Overcoat 106. Light-off test was performed under rich exhaust conditions. Example #1 ZPGM TWC system light-off test results 300 was obtained by performing light-off tests on samples after aging. The aging was performed at 900° C. for 4 hrs under dry air. Under rich condition, The T50 for hydrocarbon is 341° C. and T50 of CO is 281° C. The T50 for NOₓ conversion is 365° C.

FIG. 4 shows example #1 ZPGM TWC system light-off test results 400, in which example #1 ZPGM catalyst system may be formulated with 4-20% by weight of Mn, lanthanum doped alumina, and suitable OSM in Washcoat 104; 10-16% by weight of Cu, 10-20% by weight of Ce, lanthanum doped alumina, and suitable OSM in Overcoat 106. Light-off test was performed under lean exhaust conditions. Example #1 ZPGM TWC system light-off test results 400 was obtained by performing light-off tests on samples after aging. The aging was performed at 900° C. for 4 hrs under dry air. Under lean condition, The T50 for hydrocarbon IS 348° C. and T50 of CO is 249° C.

Example #2 is an embodiment of ZPGM TWC System 100 that includes the following Washcoat 104 and Overcoat 106 compositions:

| | | | CARRIER MATERIAL |
|---|---|---|---|
| LAYER | ZPGM | OSM | OXIDES |
| WASHCOAT | Ce | — | Alumina |
| OVERCOAT | Mn—Cu | Ce—Zr—Nd—Pr | Lathanum doped |
| | | | alumina |

The light-off test measures the conversions of carbon monoxide and hydrocarbons as a function of the ZPGM TWC System 100 temperature. For a specific temperature, a higher conversion signifies a more efficient ZPGM TWC System 100. Conversely, for a specific conversion, a lower temperature signifies a more efficient ZPGM TWC System 100.

FIG. 5 shows example #2 ZPGM TWC system light-off test results 500, in which example #2 ZPGM catalyst system may be formulated with 10-20% by weight of Ce, alumina, and no OSM in Washcoat 104; 4-20% by weight of Mn, 10-16% by weight of Cu, lanthanum doped alumina, and suitable OSM in Overcoat 106. Light-off test was performed under rich exhaust conditions. Example #2 ZPGM TWC system light-off test results 500 was obtained by performing light-off tests on samples after aging. The aging was performed at 900° C. for 4 hrs under dry air. Under rich condition, the T50 for hydrocarbon may be 349° C. and T50 of CO may be 302° C. Additionally, the T50 for NOₓ conversion may be 390° C.

FIG. 6 shows example #2 ZPGM TWC system light-off test results 600, in which example #2 ZPGM catalyst system may be formulated with 10-20% by weight of Ce, alumina, and no OSM in Washcoat 104; 4-20% by weight of Mn, 10-16% by weight of Cu, lanthanum doped alumina, and suitable OSM in Overcoat 106. Light-off test was performed under lean exhaust conditions Example #2 ZPGM TWC system light-off test results 600 was obtained by performing light-off tests on samples after aging. The aging was performed at 900° C. for 4 hrs under dry air. Under lean condition, The T50 for hydrocarbon is 388° C. and T50 of CO is 290° C.

Example #3 is an embodiment of ZPGM TWC System 100 that includes the following Washcoat 104 and Overcoat 106 compositions:

| | | | CARRIER MATERIAL |
|---|---|---|---|
| LAYER | ZPGM | OSM | OXIDES |
| WASHCOAT | Mn | — | Alumina |
| OVERCOAT | Cu—Ce | Ce—Zr—Nd—Pr | Lathanum doped |
| | | | alumina |

FIG. 7 shows example #3 ZPGM TWC system light-off test results 700, in which example #3 ZPGM TWC System 100 may be formulated with 4-20% by weight of Mn, alumina and no OSM in washcocat 104; 10-20% by weight of Ce, 10-16% by weight of Cu, lanthanum doped alumina and suitable OSM in Overcoat 106. Light-off test was performed under rich exhaust conditions. Example #3 ZPGM TWC system light-off test results 700 was obtained by performing light-off tests on samples after aging. The aging was performed at 900° C. for 4 hrs under dry air. Under rich condition, the T50 for hydrocarbon is 399° C. and T50 of CO is 283° C. Additionally, the T50 for NOₓ conversion is 379° C.

FIG. 8 shows example #3 ZPGM TWC system light-off test results 800, in which example #3 ZPGM TWC System 100 may be formulated with 4-20% by weight of Mn, alumina and no OSM in washcocat 104; 10-20% by weight of Ce, 10-16% by weight of Cu, lanthanum doped alumina and suitable OSM in Overcoat 106. Light-off test was performed under lean exhaust conditions. Example #3 ZPGM TWC system light-off test results 800 was obtained by performing light-off tests on samples after aging. The aging was performed at 900° C. for 4 hrs under dry air. Under lean condition, the T50 for hydrocarbon is 388° C. and T50 of CO is 236° C.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

What is claimed is:

1. An apparatus for reducing emissions from an engine having associated therewith an exhaust system, the apparatus leading to a reaction effective for selective catalytic reduction, comprising:
a catalyst system, comprising:
a substrate;
a washcoat suitable for deposition on the substrate, comprising at least one oxide solid selected from the group consisting of at least one of a carrier material oxide, and a zero platinum group metal (ZPGM) catalyst; and
an overcoat suitable for deposition on the substrate, comprising at least one overcoat oxide solid selected from the group consisting of at least one of a carrier material oxide, and a ZPGM catalyst.

2. The apparatus of claim 1, wherein the washcoat ZPGM catalyst comprises one or more elements selected from the group consisting of copper, cerium, and manganese, and wherein the washcoat carrier metal oxide comprises lanthanum doped alumina.

3. The apparatus of claim 2, wherein the washcoat further comprises an oxygen storage material comprising one or more elements selected from the group consisting of at least cerium, zirconium, neodymium, praseodymium, samarium, lanthanum, and yttrium.

4. The apparatus of claim 2, wherein the washcoat ZPGM catalyst comprises about 4% to about 20% by weight manganese.

5. The apparatus of claim 1, wherein the overcoat ZPGM catalyst comprises one or more elements selected from the group consisting of copper, cerium, and manganese, and wherein, when the overcoat is the carrier material oxide, it comprises lanthanum doped alumina.

6. The apparatus of claim 5, wherein the overcoat further comprises an oxygen storage material comprising one or more elements selected from the group consisting of at least cerium, zirconium, neodymium, praseodymium, samarium, lanthanum, and yttrium.

7. The apparatus of claim 5, wherein the overcoat ZPGM catalyst comprises about 10% to about 16% copper and about 10% to about 20% cerium.

8. The apparatus of claim 1, wherein the washcoat ZPGM catalyst comprises cerium, and wherein the overcoat is the ZPGM catalyst which comprises at least one element selected from the group consisting of at least copper and manganese.

9. The apparatus of claim 8, wherein the washcoat ZPGM catalyst comprises about 10% to about 20% by weight cerium.

10. The apparatus of claim 1, wherein the overcoat ZPGM catalyst comprises one or more elements selected from the group consisting of copper, and manganese, and wherein the overcoat carrier material oxide comprises lanthanum doped alumina.

11. The apparatus of claim 10, wherein the overcoat further comprises an oxygen storage material comprising one or more elements selected from the group consisting of cerium, zirconium, neodymium, praseodymium, samarium, lanthanum, and yttrium.

12. The apparatus of claim 10, wherein the overcoat ZPGM catalyst comprises about 4% to about 20% manganese and about 10% to about 16% copper.

13. The apparatus of claim 1, wherein the washcoat ZPGM catalyst comprises at least one element selected from the group consisting of cerium, and manganese, and the overcoat comprises copper.

14. The apparatus of claim 13, wherein the washcoat ZPGM catalyst comprises about 4% to about 20% by weight manganese.

15. The apparatus of claim 1, wherein the overcoat ZPGM catalyst comprises one or more elements selected from the group consisting of copper, and cerium, and wherein the overcoat carrier material oxide comprises lanthanum doped alumina.

16. The apparatus of claim 15, wherein the overcoat further comprises an oxygen storage material comprising one or more elements selected from the group consisting of cerium, zirconium, neodymium, praseodymium, samarium, lanthanum, and yttrium.

17. The apparatus of claim 15, wherein the overcoat ZPGM catalyst comprises about 10% to about 16% copper and about 10% to about 20% cerium.

18. The apparatus of claim 1, wherein the T50 conversion temperature for carbon monoxide is less than 310 degrees Celsius

19. The apparatus of claim 1, wherein the T50 conversion temperature for carbon monoxide is less than 300 degrees Celsius.

20. The apparatus of claim 1, wherein the T50 conversion temperature for nitrogen oxide is less than 400 degrees Celsius.

21. The apparatus of claim 1, wherein the T50 conversion temperature for hydrocarbons is less than 350 degrees Celsius.

22. The apparatus of claim 1, wherein the T50 conversion temperature for hydrocarbons is less than 400 degrees Celsius.

23. The apparatus of claim 1, wherein the washcoat ZPGM catalyst comprises manganese, and the overcoat comprises at least one element selected from the group consisting of copper, and cerium.
